(19) United States
(12) Patent Application Publication
(10) Pub. No.: US 2011/0206602 A1
(43) Pub. Date: Aug. 25, 2011

(54) PRODUCTION OF HYDROGEN FROM HEAVY HYDROCARBONS

(75) Inventors: Walter Jehle, Horgenzell (DE); Oliver Sonntag, London (GB); Michael Stockenhuber, Bolwarra Heights (AU)

(73) Assignee: EADS DEUTSCHLAND GMBH, Ottobrunn (DE)

(21) Appl. No.: 12/671,665

(22) PCT Filed: Jul. 31, 2008
(86) PCT No.: PCT/EP08/60101

§ 371 Date: Jul. 15, 2010

(30) Foreign Application Priority Data
Aug. 1, 2007 (DE) 10 2007 036 495.6

(51) Int. Cl. C01B 3/26; B01J 8/02

(52) U.S. Cl. 423/651; 422/211

(57) ABSTRACT

Methods and devices for producing hydrogen from heavy hydrocarbons (>C8) by catalytic partial dehydrogenation by means of a catalyst that contains at least one noble metal are described. The catalyst additionally contains one or more of the substances: Ni, Ce, Sn, Zr, Ti, which protect the catalyst from being poisoned by the sulfur contained in the hydrocarbons.

### BACKGROUND OF THE INVENTION

1. Field of the Invention

The invention relates to a method for the production of hydrogen from heavy hydrocarbons by partial catalytic dehydrogenation by means of a catalyst containing at least one noble metal, and to an apparatus for the production of hydrogen from heavy hydrocarbons by partial catalytic dehydrogenation by means of a catalyst containing at least one noble metal.

2. Background Information

A catalytic production of hydrogen from heavy hydrocarbons (>C8) is of particular interest for the production of hydrogen from aviation fuels or diesel, for example.

To date, no possibility of producing hydrogen from heavy hydrocarbons by partial dehydrogenation is known, wherein carbon monoxide-free hydrogen can be produced, for example, from aviation fuels or diesel. Sulfur-containing components present in the fuel are of importance, as they lead to rapid poisoning of the catalyst. Hitherto known processes for the production of hydrogen from aviation fuels require two separate catalytic units. First, in a catalytic hydrodesulfurization (HDS), the fuel is cleaned of thiophenes and derivatives. In a second step, the fuel is catalytically reformed, by means of either dry or oxidation reforming.

All known reforming methods, such as steam reforming, partial oxidation or autothermal reforming require the addition of an oxidant. The product is hydrogen together with water, CO, CO₂. The reactions take place at temperatures about 1000° C.

Partial dehydrogenation is typically carried out across palladium or platinum catalysts without additional substances having to be added. The fuel present in the form of heavy hydrocarbons is partially dehydrogenated and forms unsaturated hydrocarbons. For example, paraffin is transformed to olefins and hydrogen.

A great advantage of partial dehydrogenation compared to other reforming methods is that carbon monoxide is not contained in the product. Problems of the conventional method are, however, that the additional HDS stage requires additional overhead in cost and energy and the additional introduction of hydrogen. The prior art reforming methods (steam reforming, autothermal reforming and partial oxidation) require further reactants and produce undesirable byproducts, such as CO and CO₂. Palladium and platinum catalysts are well known for being rapidly poisoned by the sulfur contained in the fuel, as mentioned above (in aviation fuel jet Al up to 3000 ppm sulfur are contained according to ASTM).

### SUMMARY OF THE INVENTION

It is the object of the present invention to provide an improved method for producing hydrogen from heavy hydrocarbons by means of partial catalytic dehydrogenation. Furthermore, an improved apparatus for such partial catalytic dehydrogenation is to be suggested.

The problem is solved by a method for producing hydrogen from heavy hydrocarbons by means of partial catalytic dehydrogenation according to claim 1. Furthermore, the problem is solved by an apparatus for the production of hydrogen from heavy hydrocarbons by partial catalytic dehydrogenation having the features of claim 9. Advantageous embodiments and further developments of the invention are defined in the respective dependent claims.

According to the present invention, a method is provided for producing hydrogen from heavy hydrocarbons by partial catalytic dehydrogenation by means of a catalyst containing at least one noble metal.

According to the invention it is provided that the catalyst additionally contains one or more of the substances Ni, Ce, Sn, Zr, Ti.

The noble metal of the catalyst can include palladium and/or platinum.

In particular, sulfur-containing hydrocarbons can be dehydrogenated by means of the method according to the present invention.

It is particularly advantageous if the catalytic dehydrogenation of the heavy hydrocarbons can be carried out directly in a one-stage process.

The catalytic dehydrogenation can be carried out at temperatures below 900 K.

The catalytic dehydrogenation can be carried out at temperatures starting from 473 K.

It is advantageous that the catalyst can be regenerated.

Regeneration can be carried out at elevated temperatures in an oxygen-containing or hydrogen-containing atmosphere.

Furthermore, the present invention provides an apparatus for the production of hydrogen from heavy hydrocarbons by means of partial catalytic dehydrogenation, having a feeding means for supplying heavy hydrocarbons and a catalyst containing at least one noble metal. According to the present invention, it is provided that the catalyst additionally contains one or more of the substances Ni, Ce, Sn, Zr, Ti.

The apparatus according to the present invention is configured for carrying out the method according to the present invention.

The noble metal of the catalyst can include palladium and/or platinum.

According to an advantageous embodiment of the catalyst, it is formed by a carrier material carrying the noble metal and the at least one additional substance.

The carrier material advantageously has a high specific surface area.

The carrier material can be Al₂O₃, TiO₂, SiO₂ or activated carbon, or any other suitable material.

The additional substances can be provided in metallic form.

Alternatively or additionally, the additional substances can be provided in the form of salts.

The salts can be chlorides, nitrates or acetates, or any other suitable salts.

The additional substances can be provided in the form of clusters.

The clusters can be embedded in the carrier material.

Alternatively or additionally, the clusters can be embedded in the noble metal.

The additional substances can also or additionally be provided in the form of an alloy with the noble metal.

The additional substances can be provided in the form of a coating on the carrier material.

The catalyst can be provided in the form of pellets or rings.

The catalyst can be provided in the form of a powder or washcoat.

The apparatus is preferably provided for the production of hydrogen from standard aviation and automotive fuels. The feeding means is thus preferably configured for supplying aviation fuels, such as kerosene, or diesel or petrol. For example, the apparatus is on board of a vehicle or aircraft and connected to the fuel tank.

### BRIEF DESCRIPTION OF THE DRAWINGS

Exemplary embodiments of the invention will be explained in the following with reference to the accompanying drawings, wherein:

FIGS. 1a to 1c show three exemplary embodiments of a catalyst according to the present invention for producing hydrogen from heavy hydrocarbons by means of partial catalytic dehydrogenation; and

FIG. 2 shows an exemplary embodiment of an apparatus for the production of hydrogen from fuel on board an aircraft.

### DETAILED DESCRIPTION OF THE PREFERRED EMBODIMENTS

By means of the catalyst, heavy hydrocarbons (>C8), in particular those containing sulfur-containing components, such as aviation fuels, can be dehydrogenated producing hydrogen without an additional stage being necessary for hydrodesulfurization (HDS). The desulfurization is carried out together with the dehydrogenation in a common stage. The production of hydrogen by means of catalytic dehydrogenation can be carried out for heavy hydrocarbons present in the gas or liquid phase or even in the supercritical state. The produced hydrogen is of high purity and is available for a great variety of applications.

The catalytic dehydrogenation can be carried out at temperatures below 900 K, partial catalytic dehydrogenation is possible from as little as 473 K.

The catalyst can be regenerated, for example at elevated temperatures in an oxygen-containing atmosphere, such as at temperatures starting from 473 K.

The catalyst includes a noble metal in the form of palladium or platinum or both, and one or more additional substances. These additional substances can be Ni, Ce, Sn, Zr, Ti. The additional substances, which can be present in the form of salts and/or metals, have the function on the one hand to chemically stabilize the catalyst and on the other hand to promote the dehydrogenation and the HDS process happening conjointly. The catalyst is not poisoned by the sulfur contained in the heavy hydrocarbons due to the effect of the additional substances.

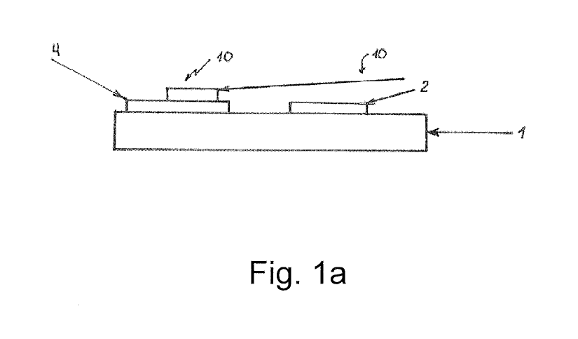

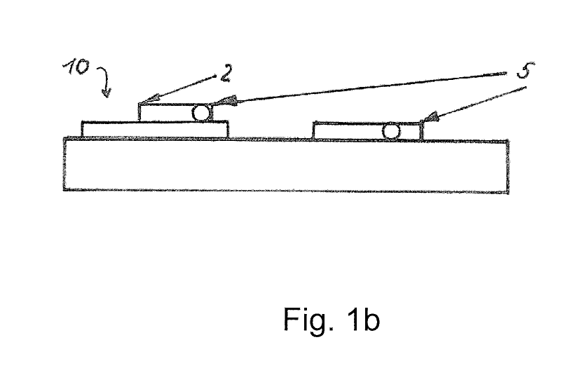

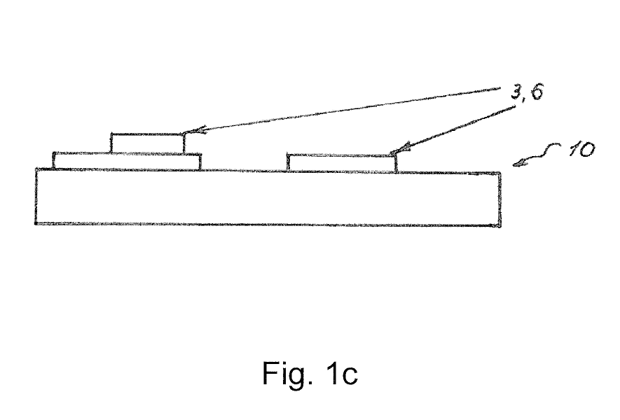

FIGS. 1a to 1c show three exemplary embodiments of such a catalyst 10. In each, a carrier material 1 is provided which carries the noble metal 2, 3 and the at least one additional substance 4, 5, 6. Carrier material 1 has a high specific surface area, i.e. it has a high ratio of surface to volume. Carrier material 1 can be, for example, Al₂O₃, TiO₂, SiO₂ or activated carbon.

The exemplary embodiment according to FIG. 1a includes catalyst 10 in the form of platinum on carrier material 1, as well as additional substances 4 in the form of tin in oxidized form.

In the exemplary embodiment according to FIG. 1b, metallic tin in the form of clusters 5 is additionally provided which, in the present case, are embedded in the metal 2 of catalyst 10.

In the exemplary embodiment according to FIG. 1c, finally, the additional substance 6 is again tin, however in the form of an alloy with the catalyst material 3, so that a platinum-tin alloy is formed.

The additional substances, which can be interpreted as promoters and/or stabilizers, can thus be metals or metal oxides or salts of the mentioned metals. They can be provided as a component of carrier material 1 or embedded and/or alloyed with material 2, 3 of catalyst 10 or in any other suitable manner as a component of catalyst 10.

Application can be carried out by means of coating or impregnating. Aqueous solutions of the relevant metal salts, chlorides, nitrates or acetates, are particularly suitable examples.

The noble metals 2, 3 forming the actual catalytically active substance can be applied in a similar manner, i.e. by means of coating, impregnating or embedding within a carrier material 1.

Catalyst 10 can be provided in the form of pellets or rings, or in the form of a powder or washcoat, or in any other suitable form.

The additional substances acting as a promoter and/or stabilizer can be provided alone or in combination, a combination of metals and salts is also possible. It is advantageous that standard coating methods are suitable for coating, such as washcoating, impregnating, exchanging.

It was found that the catalyst 10 can be regenerated without significant change in its performance.

The catalyst enables a simple one-stage process for hydrogen production from sulfur-containing fuels, wherein the produced hydrogen is of high purity. Furthermore, the moderate processing conditions facilitated by the catalyst are also advantageous.

It is highly advantageous that the catalyst is not prone to poisoning by the sulfur contained in the fuel. Sulfur depositing on the catalyst is reduced and removed together with the hydrogen in the form of hydrogen sulfide. It is thus possible to produce hydrogen by means of partial dehydrogenation, also from sulfur-containing hydrocarbons without previous desulfurization.

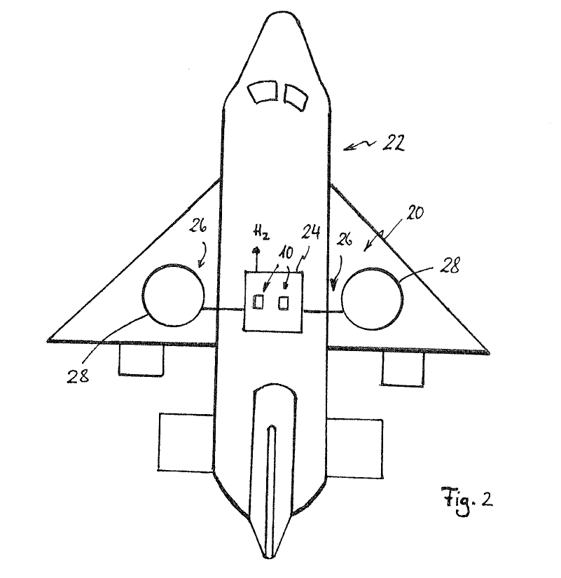

FIG. 2 shows an apparatus 20 for the production of hydrogen from heavy hydrocarbons on board a vehicle, in particular an aircraft, in the present example an airplane 22. Apparatus 20 includes a reformer 24 with a catalyst 10 according to any one of the three exemplary embodiments shown in FIGS. 1a to 1c, and a supply means 26 for supplying heavy hydrocarbons. The supply means 26 comprises a tank 28 filled or able to be filled with the usual aviation fuel as a heavy hydrocarbon.

1. A method for producing hydrogen from heavy hydrocarbons, comprising:
conducting partial catalytic dehydrogenation using a catalyst containing at least one noble metal,
the catalyst additionally containing one or more of the substances Ni, Ce, Sn, Zr, Ti.

2. The method according to claim 1, wherein
the noble metal includes palladium and/or platinum.

3. The method according to claim 1, wherein
sulfur-containing hydrocarbons are dehydrogenated.

4. The method according to claim 1, wherein
the catalytic dehydrogenation of the heavy hydrocarbons is carried out directly in a one-stage process.

5. The method according to according claim 1, wherein
the catalytic dehydrogenation is carried out at temperatures below 900 K.

6. The method according to claim 1, wherein
the catalytic dehydrogenation is carried out at temperatures starting from 473 K.

7. The method according to claim 1, wherein
the catalyst is regenerated.

8. The method according to claim 7, wherein
the regeneration is carried out at elevated temperatures in an oxygen-containing or hydrogen-containing atmosphere.

9. An apparatus for the generation of hydrogen from heavy hydrocarbons by partial catalytic dehydrogenation, comprising:
a supply device configured to supply heavy hydrocarbons; and
a catalyst containing at least one noble metal and at least one additional substance being one or more of the substances Ni, Ce, Sn, Zr, Ti.

10. The apparatus according to claim 9, wherein
the noble metal includes palladium and/or platinum.

11. The apparatus according to claim 9, wherein
the catalyst is formed by a carrier material carrying the noble metal and the at least one additional substance.

12. The apparatus according to claim 11, wherein
the carrier material has a high specific surface area.

13. The apparatus according to claim 12, wherein
the carrier material is Al₂O₃, TiO₂, SiO₂ or activated carbon.

14. The apparatus according to claim 9, wherein
the at least one additional substance is provided in metallic form.

15. The apparatus according to claim 9, wherein
the at least one additional substance is provided in the form of of at least one salt.

16. The apparatus according to claim 15, wherein
the at least one salt is chosen from the group of chlorides, nitrates, or acetates.

17. The apparatus according to claim 14, wherein
the at least one additional is provided in the form of at least one cluster.

18. The apparatus according to claim 17, wherein
the at least one cluster is embedded in the carrier material.

19. The apparatus according to claim 17, wherein
the at least one cluster is embedded in the noble metal.

20. The apparatus according to claim 14, wherein
the at least one additional substance is provided in the form of an alloy with the noble metal.

21. The apparatus according to claim 14, wherein
the at least one additional is provided in the form of a coating on the carrier material.

22. The apparatus according to claim 9, wherein the catalyst is provided in the form of pellets or rings.

23. The apparatus according to claim 9, wherein the catalyst is provided in the form of a powder or washcoat.

24. The apparatus according to claim 9, wherein
the supply means supplies an aviation fuel, diesel, or petrol as heavy hydrocarbons.

25. The apparatus according to claim 24, wherein the supply device includes a vehicle tank.
